(19) United States
(12) Patent Application Publication
(10) Pub. No.: US 2025/0174009 A1
(43) Pub. Date: May 29, 2025

(54) MACHINE LEARNING DEVICE, FEATURE EXTRACTION DEVICE, AND CONTROL DEVICE

(71) Applicant: FANUC CORPORATION, Minamitsuru-gun, Yamanashi (JP)

(72) Inventor: Taiga SATOU, Minamitsuru-gun, Yamanashi (JP)

(73) Assignee: FANUC CORPORATION, Minamitsuru-gun, Yamanashi (JP)

(21) Appl. No.: 18/842,506

(22) PCT Filed: Mar. 17, 2022
(86) PCT No.: PCT/JP2022/012453

§ 371 Date: Aug. 29, 2024

(51) Int. Cl. G06V 10/77; G06T 3/4038; G06V 10/75

(52) U.S. Cl. CPC G06V 10/7715; G06T 3/4038; G06V 10/751

(57) ABSTRACT

A machine learning device includes: a training data acquisition unit which acquires, as a training data set, data pertaining to a plurality of different filters which are applied to images in which a subject is imaged, and data indicating the state for each predetermined section of a plurality of filtered images which have been processed by the plurality of filters; and a learning unit which uses the training data set to generate a training model which outputs a synthesis parameter for synthesizing the plurality of filtered images for each corresponding section.

### CROSS REFERENCE TO RELATED APPLICATIONS

This is the U.S. National Phase application of PCT/JP2022/012453 filed Mar. 17, 2022, the disclosure of this application being incorporated herein by reference in its entirety for all purposes.

### FIELD OF THE INVENTION

The present invention relates to an image processing technology, and in particular, relates to a machine learning device, a feature extraction device, and a controller.

### BACKGROUND OF THE INVENTION

When a machine such as a robot or a machine tool performs a variety of operations on a workpiece having an unknown position and posture, the position and posture of the workpiece may be detected using an image in which the workpiece is captured. For example, a model feature representing a specific part of the workpiece is extracted from a model image obtained by capturing a workpiece having a known position and posture, and the model feature of the workpiece is registered together with the position and posture of the workpiece. Next, a feature representing a specific part of the workpiece is similarly extracted from an image of a workpiece having an unknown position and posture, and is compared with the model feature registered in advance to determine the displacement amounts of the position and posture of the workpiece feature, whereby the position and posture of the workpiece having an unknown position and posture can be detected.

As the workpiece feature used for feature matching, the outline of the workpiece (i.e., the edges and corners of the workpiece) which captures the brightness changes (gradients) in the image is often used. The features of the workpiece used for feature matching vary greatly depending on the type and size of the applied image filter (also referred to as a spatial filtering). Types of filters include noise removal filters, and contour extraction filters as usage types, and as algorithm types, the noise removal filters include mean value filters, median filters, Gaussian filters, and expansion/contraction filters, and the contour extraction filters includes edge detection filters such as a Prewitt filter, a Sobel filter, or a Laplacian filter, and corner detection filters such as a Harris operator.

In such an image filter, the appearance of extracted workpiece features can change simply due to changes in the filter type, size, etc. For example, although a small-sized contour extraction filter is effective for extracting relatively fine contours such as text printed on a workpiece, it is ineffective for extracting relatively coarse contours such as rounded corners of castings. For rounded corners, a large contour extraction filter is effective. Thus, it is necessary to specify the appropriate filter type, size, etc., for each predetermined section depending on the detection target and imaging conditions. Background technologies related to the present application include those described below.

Japanese Unexamined Patent Publication (Kokai) No. 2015-145050 (Patent Literature 1) describes that for a visual servo of a robot, the distance (difference in feature amount) is detected and weighted for each of the feature amounts (image feature amounts related to the center of gravity, edges, and pixels) of a plurality of different images from an image including the workpiece and a target image, the weighted distances are summed for all image feature amounts, a result is generated as a control signal, and an operation to change one or both of the position and posture of the workpiece is performed based on the control signal.

Japanese Unexamined Patent Publication (Kokai) No. 2005-079856 (Patent Literature 2) describes that edge detection is performed from an image using an edge detection filter consisting of multiple sizes, areas which are not edges are extracted as flat areas, and for the extracted flat areas, a transmittance map is created by calculating the relative ratio between the value of a pixel of interest and the average value of the values of surrounding pixels in the pixel range corresponding to the size of the edge detection filter, and the image of the flat area is corrected using the created transmittance map to remove dust shadows or the like.

### PATENT LITERATURE

[PTL 1] Japanese Unexamined Patent Publication (Kokai) No. 2015-145050
[PTL 2] Japanese Unexamined Patent Publication (Kokai) No. 2005-079856

### SUMMARY OF THE INVENTION

Since the image area used for feature matching is not necessarily suitable for extracting the features of the workpiece, there may be areas where the filter reaction is weak depending on the type and size of the filter. By setting a low threshold in threshold-processing after filter processing, it is possible to extract contours from areas where reaction is weak, but unnecessary noise is also extracted, which increases the time for feature matching. Furthermore, slight changes in imaging conditions may cause the features of the workpiece to not be extracted.

In view of the problems of the prior art, an object of the present invention is to provide a technology with which features of a workpiece can quickly and stably be extracted from an image of the workpiece.

An aspect of the present disclosure provides a machine learning device, comprising a learning data acquisition part which acquires, as a learning data set, data regarding a plurality of different filters applied to images in which a workpiece is captured, and data indicating a state of each predetermined section of a plurality of filtered images processed by the plurality of filters, and a learning part which uses the learning data set to generate a learning model that outputs a composition parameter for compositing the plurality of filtered images for each corresponding section.

Another aspect of the present disclosure provides a feature extraction device for extracting a feature of a workpiece from an image in which the workpiece is captured, the device comprising a plurality of filter processing parts for processing the image captured by the workpiece using a plurality of different filters to generate a plurality of filtered images, and a feature extraction image generation part for generating and outputting a feature extraction image of the workpiece by compositing the plurality of filtered images based on a composite ratio for each corresponding section of the plurality of filtered images.

Yet another aspect of the present disclosure provides a controller for controlling operations of a machine based on at least one of a position and posture of a workpiece detected from an image in which the workpiece is captured, the controller comprising a feature extraction part for processing the image in which the workpiece is captured with a plurality of different filters to generate a plurality of filtered images, compositing the plurality of filtered images based on a composite ratio for each corresponding section of the plurality of filtered images and extracting a feature of the workpiece, a feature matching part for comparing the extracted feature of the workpiece with a model feature extracted from a model image in which the workpiece, for which at least one of position and posture is known, is captured, and detecting at least one of the position and posture of the workpiece, for which at least one of position and posture is unknown, and a control part for controlling the operations of the machine based on at least one of the detected position and posture of the workpiece.

According to the present disclosure, a technology with which features of a workpiece can quickly and stably be extracted from an image of the workpiece can be provided.

### BRIEF DESCRIPTION OF DRAWINGS

FIG. 1 is a configuration view of a machining system according to an embodiment.

FIG. 2 is a block diagram of a machining system according to an embodiment.

FIG. 3 is a block diagram of an embodiment of a feature extraction device.

FIG. 4 is a flowchart showing an execution procedure of the machining system during model registration.

FIG. 5 is a flowchart showing an execution procedure of the machining system during system operation.

FIG. 6 is a block diagram of a machine learning device of an embodiment.

FIG. 7 is a schematic view showing examples of filter types and sizes.

FIG. 8 is a schematic view showing a method of acquiring label data.

FIG. 9 is a scatter plot showing an example of a composite ratio learning data set.

FIG. 10 is a schematic view showing a decision tree model.

FIG. 11 is a schematic view showing a neuron model.

FIG. 12 is a schematic view showing a neural network model.

FIG. 13 is a schematic view showing the configuration of reinforcement learning.

FIG. 14 is a schematic view showing reactions for each predetermined section of a plurality of filtered images.

FIG. 15 is a table showing an example of a learning data set of a set of specified number of filters.

FIG. 16 is a tree diagram showing a model of unsupervised learning (hierarchical clustering).

FIG. 17 is a flowchart showing an execution procedure of a machine learning method.

FIG. 18 is a schematic view showing an example of a user interface (UI) for setting composition parameters.

### DETAILED DESCRIPTION OF EMBODIMENTS OF THE INVENTION

The present disclosure will be described in detail below with reference to the drawings. Identical or similar elements of embodiments of the present disclosure have been assigned the same or similar reference signs. It should be noted that the embodiments of the present disclosure do not limit the technical scope of the present invention and the meanings of terms, and the technical scope of the present invention encompasses the inventions described in the claims and their equivalents.

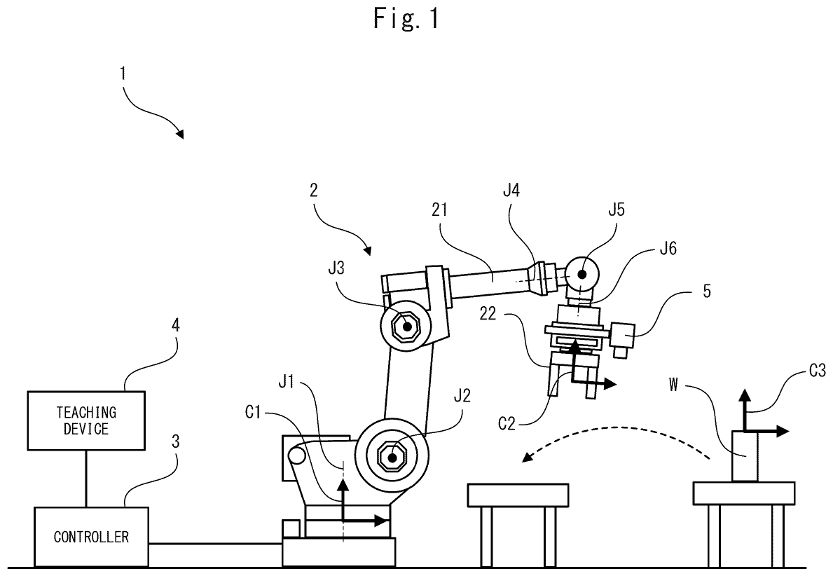

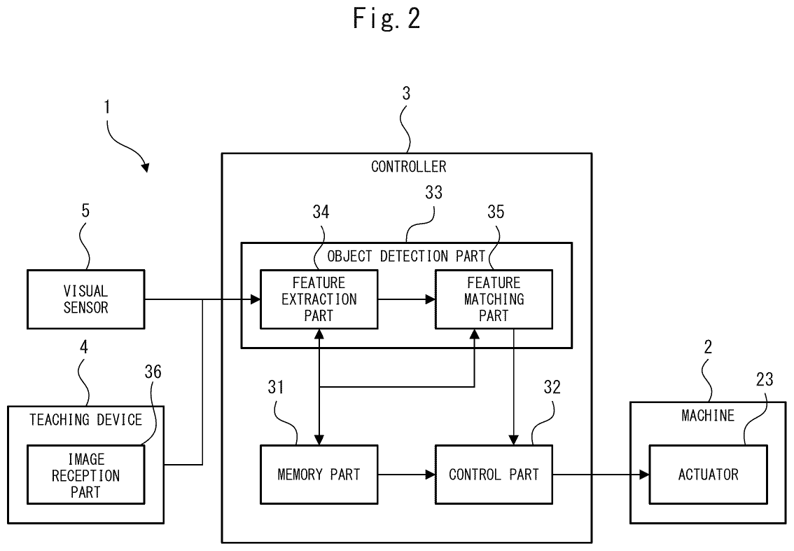

First, the configuration of a machining system 1 according to an embodiment will be described. FIG. 1 is a configuration view of the machining system 1 according to an embodiment, and FIG. 2 is a block diagram of the machining system 1 according to an embodiment. The machining system 1 is a machining system for controlling the operations of a machine 2 based on at least one of the position and posture of a workpiece W detected from an image in which the workpiece W is captured. Although the machining system 1 is a robot system, it may be configured as a machining system including other machines such as a machine tool, a construction machine, a vehicle, or an aircraft.

The machining system 1 comprises the machine 2, a controller 3 for controlling the operations of the machine 2, a teaching device 4 for teaching the operations of the machine 2, and a visual sensor 5. Although the machine 2 is constituted by an articulated robot, it may be constituted by another type of robots such as a parallel link robot or a humanoid. In another embodiment, the machine 2 may be constituted by another type of machine such as a machine tool, a construction machine, a vehicle, or an aircraft. The machine 2 comprises a mechanism part 21 composed of a plurality of machine elements that are movable relative to each other, and an end effector 22 which can be detachably connected to the mechanism part 21. The machine elements are composed of links such as a base, a rotating trunk, an upper arm, a forearm, and a wrist, and each link rotates around a predetermined axis line J1 to J6.

Although the mechanism part 21 is constituted by an electric actuator 23 including an electric motor for driving the machine elements, a detector, a speed reducer, etc., in another embodiment, it may be constituted by a fluid actuator including hydraulic or pneumatic cylinders, a pump, a control valve, etc. In addition, although the end effector 22 is a hand which removes and dispenses workpieces W, in another embodiment, it may be constituted by a tool such as a welding tool, a cutting tool, or a polishing tool.

The controller 3 is communicably connected to the machine 2 by wire. The controller 3 comprises a computer including a processor (PLC, CPU, GPU, etc.), memory (RAM, ROM, etc.), and an input/output interface (A/D converter, D/A converter, etc.), and a drive circuit for driving the actuator of the machine 2. In another embodiment, the controller 3 may not include a drive circuit, and the machine 2 may include a drive circuit.

The teaching device 4 is communicably connected to the controller 3 by wire or wirelessly. The teaching device 4 comprises a computer including a processor (CPU, MPU, etc.), memory (RAM, ROM, etc.), and an input/output interface, a display, an emergency stop switch, and an enable switch. The teaching device 4 is constituted by, for example, an operation panel directly integrated with the controller 3, a teaching pendant, a tablet, a PC, or a server which is communicably connected to the controller 3 by wire or wirelessly.

The teaching device 4 sets various coordinate systems such as a reference coordinate system C1 which is fixed to a reference position, a tool coordinate system C2 which is fixed to the end effector 22, which is a control target part, and a workpiece coordinate system C3 which is fixed to the workpiece W. The position and posture of the end effector 22 are expressed as a position and posture of the tool coordinate system C2 in the reference coordinate system C1. Although not illustrated, the teaching device 4 further sets a camera coordinate system which is fixed to the visual sensor 5, and converts the position and posture of the workpiece W in the camera coordinate system to a position and posture of the workpiece W in the reference coordinate system C1. The position and posture of workpiece W are expressed as the position and posture of workpiece coordinate system C3 in the reference coordinate system C1.

The teaching device 4 has an online teaching function such as a playback method or direct teaching method, which teaches the position and posture of the control target part by actually moving the machine 2, or an offline teaching function which teaches the position and posture of the control target part by moving a virtual model of the machine 2 in a computer-generated virtual space The teaching device 4 generates an operation program for the machine 2 by associating the taught position, posture, operation speed, etc., of the control target part with various operation commands. The operation commands include various commands such as linear movement, circular arcuate movement, and movement of each axis. The controller 3 receives the operation program from the teaching device 4 and controls the operations of the machine 2 in accordance with the operation program. The teaching device 4 receives the state of the machine 2 from the controller 3 and displays the state of the machine 2 on a display or the like.

The visual sensor 5 includes a two-dimensional camera which outputs a two-dimensional image, a three-dimensional camera which outputs a three-dimensional image, or the like. Although the visual sensor 5 is attached near the end effector 22, in another embodiment, it may be fixedly installed at a different location from the machine 2. The controller 3 detects at least one of the position and posture of the workpiece W by obtaining an image in which the workpiece W is captured using the visual sensor 5, extracting a feature of the workpiece W from the image in which workpiece W is captured, and comparing the extracted feature of the workpiece W with a model feature of the workpiece W extracted from a model image in which the workpiece W, for which at least one of the position and posture thereof is known, is captured.

It should be noted that the “position and posture of the workpiece W” as used herein are the position and posture of the workpiece W converted from the camera coordinate system to the reference coordinate system C1, and may simply be the position and posture of workpiece W in the camera coordinate system.

As shown in FIG. 2, the controller 3 comprises a memory part 31 for storing various data, and a control part 32 for controlling the operations of the machine 2 in accordance with an operation program. The memory part 31 includes memory (RAM, ROM, etc.). Although the control part 32 includes a processor (PLC, CPU, etc.) and the drive circuit for driving the actuator 23, the drive circuit may be arranged inside the machine 2, and the control part 32 may include only the processor.

The memory part 31 stores the operation program for the machine 2, various image data, and the like. The control part 32 drives and controls the actuator 23 of the machine 2 in accordance with the operation program generated by the teaching device 4 and the position and posture of the workpiece W detected using the visual sensor 5. Although not illustrated, the actuator 23 comprises one or more electric motors and one or more operation detection sections. The control part 32 controls the position, speed, acceleration, etc., of the electric motor in accordance with the command values of the operation program and the detection values of an operation detection part.

The controller 3 further comprises an object detection part 33 for detecting at least one of the position and posture of the workpiece W using the visual sensor 5. In another embodiment, the object detection part 33 may be constituted by an object detection device which is arranged outside the controller 3 and which can communicate with the controller 3.

The object detection part 33 comprises a feature extraction part 34 for extracting a feature of the workpiece W from an image in which the workpiece W is captured, and a feature matching part 35 for comparing the extracted feature of the workpiece W with a model feature extracted from a model image in which the workpiece W, for which at least one of the position and posture is known, is captured, and detecting at least one of the position and posture of the workpiece W, for which at least one of the position and posture is unknown.

In another embodiment, the feature extraction part 34 may be constituted as a feature extraction device which is arranged outside the controller 3 and which can communicate with the controller 3. Similarly, in another embodiment, the feature matching part 35 may be constituted as a feature matching device which is arranged outside the controller 3 and which can communicate with the controller 3.

The control part 32 corrects at least one of the position and posture of a control target part of the machine 2 based on at least one of the detected position and posture of the workpiece W. For example, the control part 32 may correct the position and posture data of the control target part used in the operation program of the machine 2, or may provide visual feedback by calculating the position deviation, speed deviation, acceleration deviation, etc., of one or more electric motors based on inverse kinematics from the position and posture correction amounts of the control target part during operation of the machine 2.

As described above, the machining system 1 detects at least one of the position and posture of the workpiece W from the image in which the workpiece is captured W using the visual sensor 5, and controls the operations of the machine 2 based on at least one of the position and posture of the workpiece W. However, the image area used for matching the feature of workpiece W with the model feature in the feature matching part 35 is not necessarily a location suitable for extracting the feature of workpiece W. Depending on the type, size, etc., of the filter F used by the feature extraction part 34, there may be locations where the reaction of the filter F is weak. By setting a low threshold in threshold-processing after filter processing, it is possible to extract contours from areas where reaction is weak, but unnecessary noise will also be extracted, increasing the time required for feature matching. Furthermore, the feature of workpiece W may not be extracted due to a slight change in imaging conditions.

The feature extraction part 34 processes the image in which the workpiece W is captured with a plurality of different filters F, composites the plurality of filtered images based on the composite ratio C of each corresponding section of the plurality of filtered images, and generates and outputs a feature extraction image. In order to speed up the feature extraction part 34, it is desirable to execute a plurality of filter processes in parallel.

“A plurality of different filters F” as used herein means a set of filters F in which at least one of the type and size of the filters F is changed. For example, the different filters F are constituted by three filters F of different sizes: an 8-neighbor Prewitt filter (first filter), a 24-neighbor Prewitt filter (second filter), and a 48-neighbor Prewitt filter (third filter).

Alternatively, the different filters F may be a set of filters F which are a combination of filters F with different algorithms. For example, the plurality of different filters F are constituted by a set of four filters F of different algorithms and different sizes, such as an 8-neighbor Sobel filter (first filter), a 24-neighbor Sobel filter (second filter), an 8-neighbor Laplacian filter (third filter), and a 24-neighbor Laplacian filter (fourth filter).

Furthermore, the plurality of different filters F may be a set of filters F in which filters F having different uses are combined in series and/or in parallel. For example, the plurality of different filters F are constituted by a set of four filters F having different uses and sizes such as an 8-neighbor noise removal filter (first filter), a 48-neighbor noise removal filter (second filter), an 8-neighbor contour extraction filter (third filter), and a 48-neighbor contour extraction filter (fourth filter). Alternatively, the plurality of different filters F may be constituted by a set of two filters F of different sizes, each of which is a series combination of a plurality of filters F of different uses, such as an 8-neighbor noise removal filter+a 24-neighbor contour extraction filter (first filter), and a 48-neighbor noise removal filter+80 neighbor contour extraction filter (second filter). Likewise, the plurality of different filters F may be constituted by a set of two filters F of different sizes, which are a series combination of a plurality of filters F of different uses, such as an 8-neighbor edge detection filter+an 8-neighbor corner detection filter (first filter), and a 24-neighbor edge detection filter+a 24-neighbor corner detection filter (second filter).

In addition, a “section” generally corresponds to one pixel, but may be a section constituted by neighbor pixel groups such as an 8-neighbor pixel group, a 12-neighbor pixel group, a 24-neighbor pixel group, a 48-neighbor pixel group, or an 80-neighbor pixel group. Alternatively, the “sections” may each be section of an image divided by various image segmentation techniques. Examples of image segmentation methods include deep learning and the k-means method. When using the k-means method, image segmentation may be performed based on the output result of the filter F rather than based on the RGB space. The composite ratio C and the set of different filters F for each predetermined section are set manually or automatically.

By using such a plurality of different filters F, it becomes possible to stably extract features with different appearances, such as fine features including text and coarse features including rounded corners. Further, in applications such as the machining system 1, which detects at least one of the position and posture of the workpiece W, system delays, system stoppages, etc., due to non-detection or false detection can be reduced.

Furthermore, by setting composite ratio C for each predetermined section, even if features with different appearances, such as fine features including text and coarse features including rounded corners, are mixed in one image, the desired features can be accurately extracted.

The teaching device 4 comprises an image reception part 36 which receives a model image in which workpiece W, for which at least one of the position and posture is known, is captured in association with the position and posture of the workpiece W. The image reception part 36 displays on the display a UI for receiving the model image of workpiece W in association with the position and posture of workpiece W. The feature extraction part 34 extracts and outputs the model feature of the workpiece W from the received model image, and the memory part 31 stores the output model feature of the workpiece W in association with the position and posture of the workpiece W. As a result, the model features used in the feature matching part 35 are registered in advance.

The image reception part 36 adds one or more changes to the received model image, such as brightness, enlargement or reduction, shearing, translation, rotation, etc., and may receive one or more model images having changes added thereto. The feature extraction part 34 extracts and outputs one or more model features of the workpiece W from the one or more changed model images, and the memory part 31 stores the output one or more model features of the workpiece W in association with the position and posture of the workpiece W. By adding one or more changes to the model image, since the feature matching part 35 can match the feature extracted from the image in which the workpiece W, for which at least one of the position and posture is unknown, is captured with the one or more of the model features, it becomes possible to stably detect at least one of the position and posture of the workpiece W.

The image reception part 36 may receive an adjusted image for automatically adjusting the composite ratio C for each corresponding section of the plurality of filtered images and the set of the specified plurality of filters F. The adjustment image may be a model image in which the workpiece W, for which at least one of the position and posture is known, is captured, or may be an image in which the workpiece W, for which at least one of the position and posture is unknown, is captured. The feature extraction part 34 generates the plurality of filtered images by processing the received adjusted image with the plurality of different filters W, and manually or automatically sets at least one of the composite ratio C and the specified number of filters F for each predetermined section based on the state S of each predetermined section of the plurality of filtered images.

Since the state S of each predetermined section of the plurality of filtered images changes depending on the feature (fine features such as text, coarse features such as rounded corners, strong reflections due to the color and material of the workpiece W, etc.) of the workpiece W and the imaging conditions (illuminance of reference light, exposure time, etc.), it is desirable to automatically adjust the composite ratio C and the set of different filters F for each predetermined section using machine learning, which will be described later.

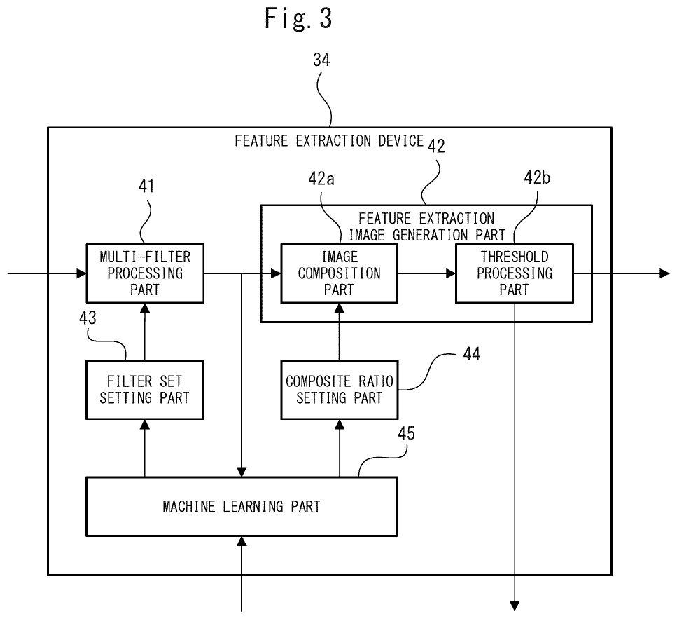

FIG. 3 is a block diagram of a feature extraction device 34 (feature extraction part) of an embodiment. The feature extraction device 34 comprises a computer including a processor (CPU, GPU, etc.), memory (RAM, ROM, etc.), and an input/output interface (A/D converter, D/A converter, etc.). The processor reads and executes a feature extraction program stored in the memory, processes an image input via the input/output interface with different filters F to generate a plurality of filtered images, and composites the plurality of filtered images based on the composite ratio C of each corresponding section of the plurality of filtered images to generate a feature extraction image of the workpiece W. The processor outputs the feature extraction image to the outside of the feature extraction device 34 via the input/output interface.

The feature extraction device 34 includes a multi-filter processing part 41 which generates the plurality of filtered images by processing the image in which the workpiece W is captured with a plurality of different filters F, and a feature extraction image generation part 42 which composites the plurality of filtered images based on the composite ratio C for each corresponding section of the plurality of filtered images, and generates and outputs the feature extraction image of the workpiece W.

The feature extraction image generation part 42 includes an image composition part 42a which composites the plurality of filtered images, and a threshold processing part 42b that threshold-processes the plurality of filtered images or composite images. In another embodiment, the feature extraction image generation part 42 may perform the processing in the order of the threshold processing part 42b and the image composition part 42a, rather than in the order of the image composition part 42a and the threshold processing part 42b. Specifically, the image composition part 42a may not be arranged before the threshold processing part 42b, but may be arranged after the threshold processing part 42b.

The feature extraction part 34 further comprises a filter set setting part 43 for setting a set of different designated numbers of filters F, and a composite ratio setting part 44 for setting the composite ratio C for each corresponding section of the plurality of filtered images. The filter set setting part 43 provides a function for manually or automatically setting the set of different designated numbers of filters F. The composite ratio setting part 44 provides a function for manually or automatically setting the composite ratio C for each corresponding section of the plurality of filtered images.

The execution procedures during model registration and during system operation in the machining system 1 will be described below. “During model registration” means the scene where model features used in feature matching for detecting the position and posture of the workpiece W are registered in advance, and “during system operation” means the scene where the machine 2 actually operates and performs the specified operations on the workpiece W.

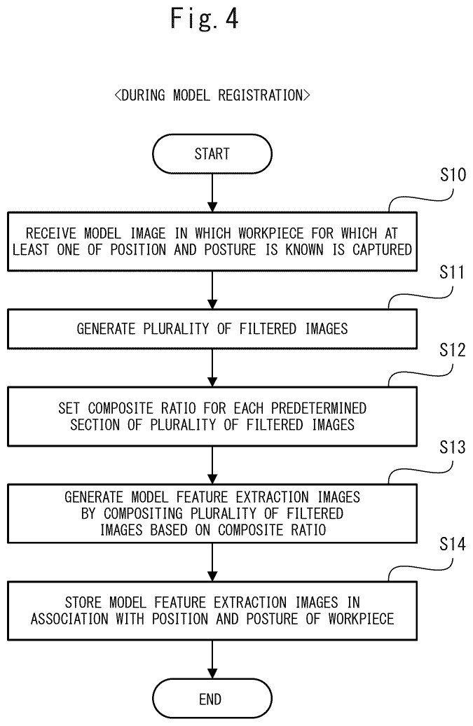

FIG. 4 is a flowchart showing the execution procedure of the machining system 1 during model registration. First, in step S10, the image reception part 36 receives the model image of the workpiece W, for which at least one of the position and posture is known, in association with at least one of the position and posture of workpiece W.

In step S11, the multi-filter processing part 41 generates a plurality of filtered images by processing the model image of the workpiece W with a plurality of different filters F. It should be noted that as a pre-processing of step S11, the filter set setting part 43 may manually set the set of a different designated number of filters F. Alternatively, as post-processing of step S11, the filter set setting part 43 may automatically set an optimal set of a different designated number of filters F based on the state S of each predetermined section of the plurality of filtered images, may return again to step S11, and after the process of generating the plurality of filtered images is repeated and an optimal set of a specified number of filters F is converged, the process may proceed to step S12.

In step S12, the composite ratio setting part 44 manually sets the composite ratio C for each corresponding section of the plurality of filtered images based on the state S of each predetermined section of the plurality of filtered images. Alternatively, the composite ratio setting part 44 may automatically set the composite ratio C for each corresponding section of the plurality of filtered images based on the state S of each predetermined section of the plurality of filtered images.

In step S13, the feature extraction image generation part 42 composites the plurality of filtered images based on the set composite ratio C, and generates and outputs the model feature extraction image (target image). In step S14, the memory part 31 stores the model feature extraction image in association with at least one of the position and posture of the workpiece W, thereby registering the model features of the workpiece W in advance.

It should be noted that after model registration, the image reception part 36 may further receive the adjusted image of the workpiece W, the filter set setting part 43 may manually or automatically reset the set of the specified number of filters F based on the received adjusted image, and the composite ratio setting part 44 may manually or automatically reset the composite ratio C for each predetermined section based on the received adjusted image. By repeating adjustment using the adjustment image, the feature extraction device 34 can provide an improvement in the feature extraction technique such that the feature of the workpiece W can be extracted stably in a short time.

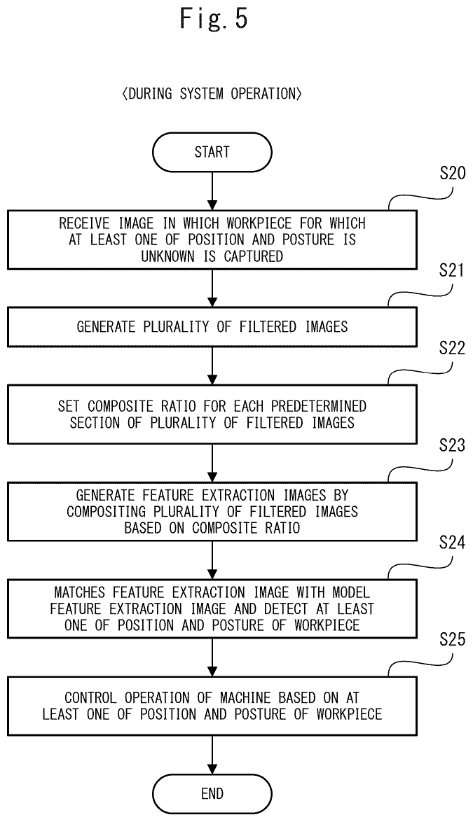

FIG. 5 is a flowchart showing the execution procedure of the machining system 1 during system operation. First, in step S20, the feature extraction device 34 receives from the visual sensor 5 an actual image in which the workpiece W, for which at least one of the position and posture is unknown, is captured.

In step S21, the multi-filter processing part 41 generates the plurality of filtered images by processing the actual image in which the workpiece W is captured with a plurality of different filters F. It should be noted that as a post-processing of step S21, the filter set setting part 43 may automatically reset the optimal set of a different designated number of filters F based on the state S of each predetermined section of the plurality of filtered images, may return again to step S11, and after repeating the process of generating the plurality of filtered images and converging on an optimal set of a specified number of filters F, the process may proceed to step S22.

In step S22, the composite ratio setting part 44 automatically resets the composite ratio C for each corresponding section of the plurality of filtered images based on the state S of each predetermined section of the plurality of filtered images. Alternatively, the process may proceed to step S23 without performing the process of step S22, and the composite ratio C for each predetermined section set in advance before system operation may be used.

In step S23, the feature extraction image generation part 42 composites the plurality of filtered images based on the set composite ratio C, and generates and outputs a feature extraction image. In step S24, the feature matching part 35 matches the generated feature extraction image with the model feature extraction image (target image) registered in advance, and detects at least one of the position and posture of the workpiece W, for which at least one of the position and posture is unknown. In step S25, the control part 32 corrects the operations of the machine 2 based on at least one of the position and posture of the workpiece W.

It should be noted that after system operation, if it takes time to detect the position and posture of the workpiece W or the cycle time of the entire system, the image reception part 36 may further receive the adjusted image in which the workpiece W is captured, and the filter set setting part 43 may manually or automatically re-set the specified number of filters F based on the received adjusted image, and the composite ratio setting part 44 may manually or automatically re-set the composite ratio C for each predetermined section based on the received adjusted image. By repeating adjustment using the adjustment image, the feature extraction device 34 can provide an improvement in the feature extraction technique such that the feature of the workpiece W can be extracted stably in a short time.

A method for automatically adjusting the composite ratio C for each predetermined section and the set of a specified number of filters F will be described in detail. The composite ratio C for each predetermined section and the set of a specified number of filters F are automatically adjusted using machine learning.

Referring again to FIG. 3, the feature extraction device 34 further comprises a machine learning part 45 for learning the state S of each predetermined section of the plurality of filtered images. In another embodiment, the machine learning part 45 may be constituted by a machine learning device which is arranged outside the feature extraction device 34 or the controller 3 and which can communicate with the feature extraction device 34 or the controller 3.

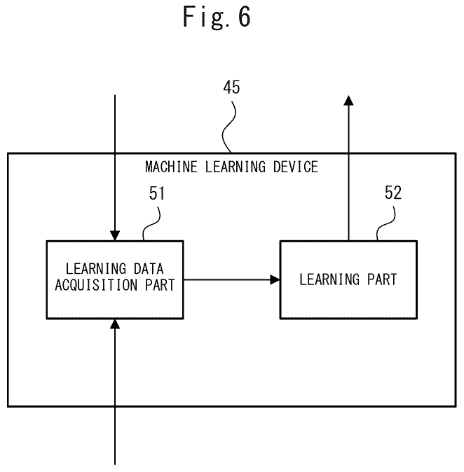

FIG. 6 is a block diagram of a machine learning device 45 (machine learning part) of an embodiment. The machine learning device 45 comprises a computer including a processor (CPU, GPU, etc.), memory (RAM, ROM, etc.), and an input/output interface (A/D converter, D/A converter, etc.). The processor reads and executes a machine learning program stored in the memory, and generates a learning model LM for outputting a composition parameter P for compositing the plurality of filtered images for each corresponding section based on input data input via the input/output interface.

Each time new input data is input via the input/output interface, the processor converts the state of the learning model LM in accordance with learning based on the new input data. Specifically, the learning model LM is optimized. The processor outputs the learned learning model LM to the outside of the machine learning device 45 via the input/output interface.

The machine learning device 45 comprises a learning data acquisition part 51 for acquiring, as a learning data set DS, data regarding the plurality of different filters F and data indicating the state S of each predetermined section of the plurality of filtered images, and a learning part 52 which generates the learning model LM for outputting the composition parameter P for compositing the plurality of filtered images using the learning data set DS.

Each time the learning data acquisition part 51 acquires a new learning data set DS, the learning part 52 converts the state of the learning model LM in accordance with learning based on the new learning data set DS. Specifically, the learning model LM is optimized. The learning part 52 outputs the generated learned learning model LM to the outside of the machine learning device 45.

The learning model LM includes at least one of a learning model LM1 for outputting a composite ratio C for each corresponding section of the plurality of filtered images, and a learning model LM2 for outputting the set of a specified number of filters F. Specifically, the composition parameter P output by the learning model LM1 is the composite ratio C for each predetermined section, and the composition parameter P output by the learning model LM2 is the set of a specified number of filters F.

<Composite Ratio C learning Model LM1>

A prediction model (learning model LM1) for the composite ratio C for each corresponding section of a plurality of filtered images will be described below. Since prediction of the composite ratio C is a prediction problem for a continuous value represented by the composite ratio (i.e., a regression problem), supervised learning, reinforcement learning, deep reinforcement learning, etc., can be used as the learning method for the learning model LM1 for outputting the composite ratio. Furthermore, as the learning model LM1, a model such as a decision tree, a neuron, a neural network, etc., can be used.

First, the generation of the learning model LM1 for the composite ratio C by supervised learning will be described with reference to FIGS. 6 to 12. The learning data acquisition part 51 acquires data regarding the plurality of different filters F as a learning data set DS, and the data regarding the plurality of filters F includes at least one of the types and sizes of the plurality of filters F.

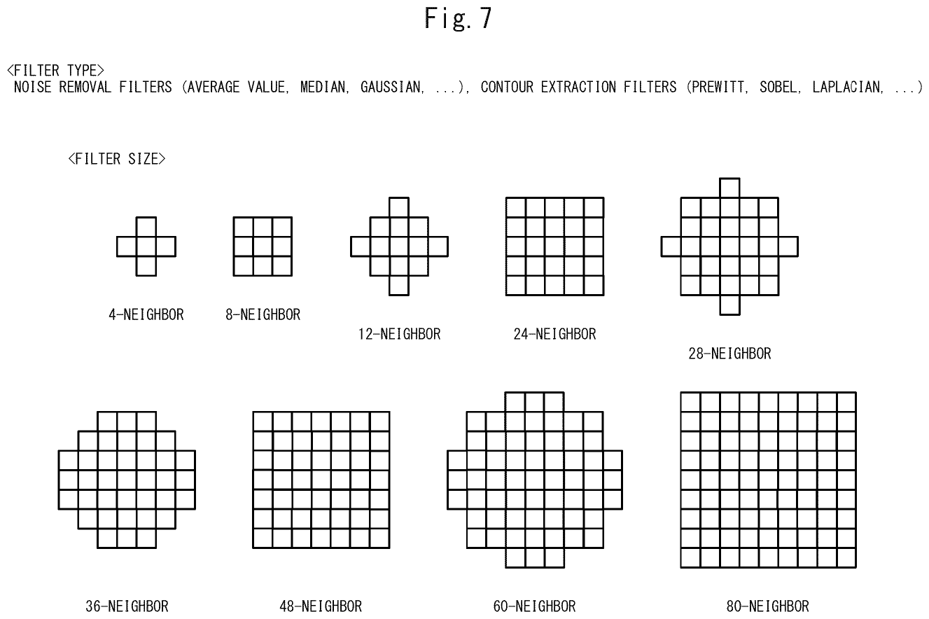

FIG. 7 is a schematic view showing examples of the types and sizes of the filters F. The types of the filters F include various filters such as noise removal filters (average value filter, median filter, Gaussian filter, expansion/contraction filter, etc.) and contour extraction filters (edge detection filters such as Prewitt filter, Sobel filter, Laplacian filter, and corner detection filters such as Harris operator). The sizes of the filters F include various sizes such as 4-neighbor, 8-neighbor, 12-neighbor, 24-neighbor, 28-neighbor, 36-neighbor, 48-neighbor, 60-neighbor, and 80-neighbor. The filter F may be square like 8-neighbor, 24-neighbor, 48-neighbor, 80-neighbor, etc., and the filter may be a cross shape in the manner of 4-neighbor, may be diamond-shaped in the manner of 12-neighbor, and may be circular in the manner of 28-neighbor, 36-neighbor, and 60-neighbor. Specifically, setting the size of the filter F means setting the shape of the filter F.

One section of a filter F generally corresponds to one pixel of an image, but may correspond to a section composed of a group of adjacent pixels, such as four adjacent pixels, nine adjacent pixels, or 16 adjacent pixels. Alternatively, one section of the filter F may correspond to each section of an image divided by various image segmentation techniques. Examples of image segmentation methods include deep learning and the k-means method. When using the k-means method, image segmentation may be performed based on the output result of the filter F, rather than based on the RGB space. Each section of the filter F includes coefficients or weights depending on the type of the filter F. Generally, when a certain image is processed by a certain filter F, the value of the section of the image corresponding to the center section of the filter F is replaced with a value calculated based on the coefficients or weights of the peripheral sections surrounding the center section of the filter F and the values of the peripheral sections of the image corresponding to the peripheral sections of the filter F.

Thus, when an image in which the workpiece W is captured is processed by a plurality of different filters F in which at least one of the type and size is changed, a plurality of different filtered images are generated. Specifically, there may be sections where the features of workpiece W are easily extracted and sections where features are difficult to extract due to simply changing at least one of the type and size of the filter F.

The data regarding the plurality of filters F includes at least one of the types and sizes of the plurality of filters F. In the present example, the data related to the plurality of filters F include one type of filter and a plurality of different sizes, such as a 4-neighbor Sobel filter (first filter), an 8-neighbor Sobel filter (second filter), a 12-neighbor Sobel filter (third filter), a 24-neighbor Sobel filter (fourth filter), a 28-neighbor Sobel filter (fifth filter), a 36-neighbor Sobel filter (sixth filter), a 48-neighbor Sobel filter (a seventh filter), a 60-neighbor Sobel filter (an eighth filter), and an 80-neighbor Sobel filter (ninth filter).

The learning data acquisition part 51 acquires the data indicating the state S of each predetermined section of the plurality of filtered images as a learning data set DS, but the data indicating the state S of each predetermined section of the plurality of filtered images includes variations in values of sections surrounding the predetermined section of the filtered image. “Variations in values of the sections surrounding” include, for example, variance values or standard deviation values of the values of the surrounding pixel groups, such as the 8-neighbor pixel group, the 12-neighbor pixel group, and the 24-neighbor pixel group.

For example, in sections surrounding a feature (such as an edge or corner) of the workpiece W desired to be used for matching, since it is assumed that variations in the values of the surrounding sections change with that feature as the boundary, it is considered that there is a correlation between the variations in the values of the surrounding sections and the composite ratio C of each corresponding section of the plurality of filtered images. It is desirable that the data indicating the state S of each predetermined section of the plurality of filtered images include variations in the values of the surrounding sections for each predetermined section.

Furthermore, the stronger the reaction of a given section after threshold-processing of the plurality of filtered images, the higher the possibility that the features of the workpiece W are suitably extracted. Thus, the data indicating the state S of each predetermined section of the plurality of filtered images may include a reaction for each predetermined section after threshold-processing the plurality of filtered images. “A reaction for each predetermined section” means the number of pixels equal to or greater than a threshold value in a predetermined pixel group, such as, for example, an 8-neighbor pixel group, a 12-neighbor pixel group, or a 24-neighbor pixel group.

When learning a prediction model with composite ratio C using supervised learning, reinforcement learning, etc., the data indicating the state S of each predetermined section of the plurality of filtered images further includes label data L indicating the degree from the normal state to the abnormal state of each predetermined section of the filtered images. The label data L is normalized such that as the value of a predetermined section of a filtered image approaches the value of the corresponding section of the model feature extraction image (target image), the label data L approaches 1 (the normal state), and such that as the value of a predetermined section of a filtered image becomes distant from the value of the corresponding section of the model feature extraction image (target image), the label data L approaches 0 (the abnormal state). In the composition of the filter image, a composite image can be brought closer to the target image by increasing the composite ratio of the filter images closer to the target image. For example, a composite image close to the target image can be obtained by learning a prediction model that estimates the label data L set in this manner and determining a composite ratio according to the label predicted by the prediction model.

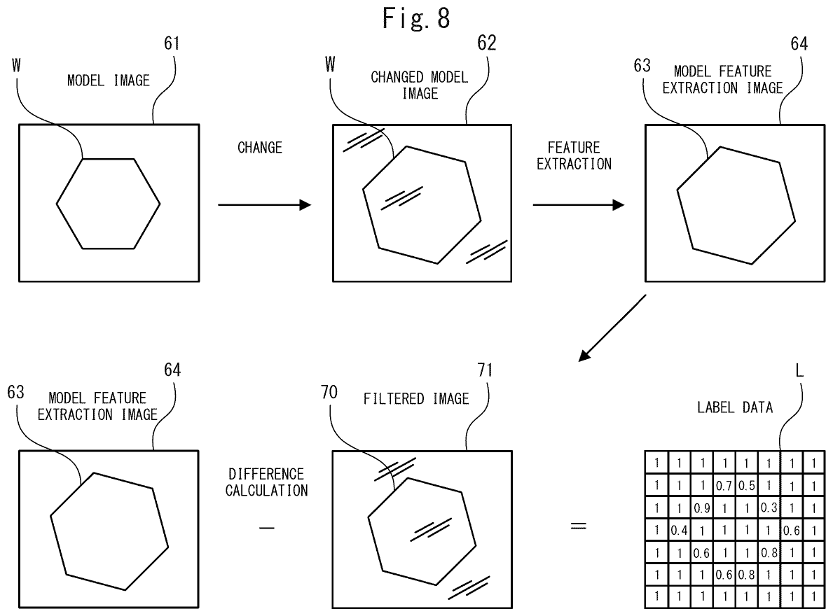

FIG. 8 is a schematic view showing a method for acquiring label data L. The upper part of FIG. 8 shows the execution procedure during model registration, and the lower part of FIG. 8 shows the execution procedure at the time of acquiring label data. As shown in the upper part of FIG. 8, first, the image reception part 36 receives a model image 61 including a workpiece W for which at least one of position and posture is known. At this time, the image reception part 36 may apply one or more changes (brightness, enlargement or reduction, shearing, translation, rotation, etc.) to the received model image 61, and receive one or more changed model images 62. The one or more changes added to the received model image 61 may be one or more changes used during feature matching.

Next, the feature extraction device 34 (feature extraction part) performs filter processing on the model image 62 according to the manually-set set of a plurality of filters F as the processing during model registration described with reference to FIG. 4 to generate the plurality of filtered images, and composites the plurality of filtered images in accordance with the manually-set composite ratio C, whereby one or more model features 63 of the workpiece W are extracted from the one or more model images 62, and the one or more model feature extraction images 64 including the model features 63 of the workpiece W are generated and output. The memory part 31 stores the one or more output model feature extraction images 64 (target images) to register the model feature extraction images 64. At this time, if the user trial and error and man-hours increase when manually setting the set of a plurality of filters F or the composite ratio, the model feature extraction images 64 may be generated manually by the user manually specifying the model features 63 (edges and corners) from the model images 62.

Subsequently, as shown in the lower part of FIG. 8, the learning data acquisition part 51 calculates the difference between each of the plurality of filtered images 71 obtained by processing an image of the workpiece W using the plurality of different filters F and the stored model feature extraction images 64 (target image), whereby label data L indicating the degree from the normal state to the abnormal state for each predetermined section of a plurality of filtered images is obtained. It should be noted that the set of filters F and composite ratio that are manually set during model registration are set manually via trial and error so that the model features 63 can be extracted from the model images 62, and if this is applied as-is to the images of the workpiece W during system operation, the features of the workpiece W may not be extracted properly depending on changes in the state of the workpiece W or changes in the imaging conditions, and thus, machine learning of the composite ratio C and the set of a plurality of filters F is necessary.

At this time, the learning data acquisition part 51 normalizes the label data L so that the closer the value of a predetermined section after the calculation of the difference is to 0 (i.e., the closer to the value of the corresponding section of the target image), the closer the label data L is to 1 (the normal state), and the further the value of the predetermined section after the calculation of the difference is from 0 (i.e., the farther from the value of the corresponding section of the target image), the closer the label data L is to 0 (the abnormal state).

Furthermore, when a plurality of model feature extraction images 64 are stored in the memory part 31, the learning data acquisition part 51 calculates the difference between one filtered image 71 and each of the plurality of model feature extraction images 64, normalizes the difference image with the most label data L close to the normal state, and adopts it as the final label data L.

As described above, the learning data acquisition part 51 acquires data regarding a plurality of different filters F and data indicating the state S of each predetermined section of the plurality of filtered images as the learning data set DS.

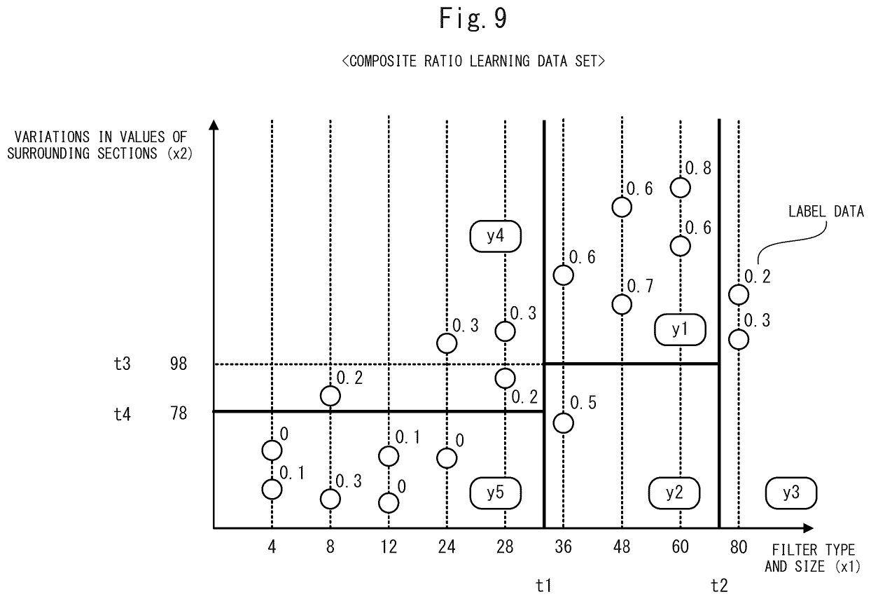

FIG. 9 is a scatter plot showing an example of a learning data set DS of the composite ratio C. The horizontal axis of the scatter plot represents the type and size of filter F (explanatory variable x1), and the vertical axis represents the variation in values of sections surrounding a predetermined section of a filtered image (explanatory variable x2). In the present example, the explanatory variable x1 includes a 4-neighbor Sobel filter (first filter) through an 80-neighbor Sobel filter (ninth filter). Furthermore, the explanatory variable x2 includes variations in the values of sections surrounding a predetermined section of a plurality of filtered images processed by the first to ninth filters (indicated by circles). The label data L (the numerical value shown on the right side of the circle) represents the degree from the normal state “1” to the abnormal state “0” of the predetermined section.

The learning part 52 generates a learning model LM1 for outputting the composite ratio C for each corresponding section of the plurality of filtered images using the learning data set DS as shown in FIG. 9.

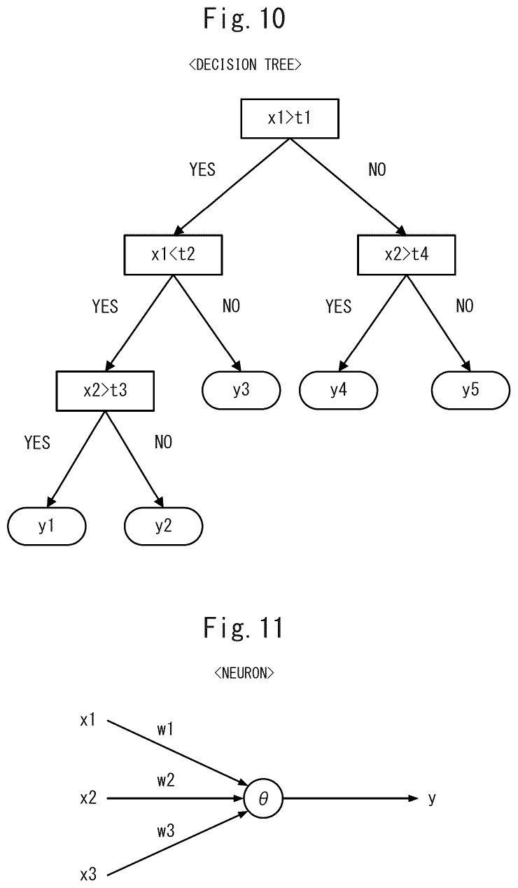

First, with reference to FIGS. 9 and 10, the case in which a decision tree model is generated as the learning model LM1 for outputting the composite ratio will be described. FIG. 10 is a schematic view showing a decision tree model. As described above, since the prediction of the composite ratio C is a continuous value prediction problem of the composite ratio C (i.e., a regression problem), the decision tree is a so-called regression tree.

The learning part 52 generates a regression tree model for outputting the objective variable y (y1 to y5 in the example of FIG. 10), which is the composite ratio, from the explanatory variable x1, which is the type and size of the filter F, and the explanatory variable x2, which is the variation in the values of the surrounding sections. The learning part 52 uses Gini impurity, entropy, etc., to divide the data so that the information gain is maximized (i.e., divides the data so that it is most clearly classified), and then generates the regression tree model.

In the example of the learning data set DS shown in FIG. 9, when the size of the Sobel filter exceeds 28 neighbors (the thick solid line indicates a branch line), since the label data L, which is close to the normal state “1”, increases (approximately 0.5 or more), the learning part 52 automatically sets “28 neighbors” as the threshold t1 of the explanatory variable x1 (type and size of filter F) in the first branch of the decision tree.

Next, when the size of the Sobel filter exceeds approximately 60 (the thick solid line indicates a branch line), since the label data L, which is close to the abnormal state “0”, increases (approximately 0.3 or less), the learning part 52 automatically sets “60 neighbors” as the threshold t2 of the explanatory variable x1 (type and size of filter F) in the second branch of the decision tree.

Next, when the variation in the values of the surrounding sections exceeds 98 (the thick solid line indicates a branch line), since the label data L, which is close to the normal state “1”, increases (approximately 0.6 or more), the learning part 52 automatically sets “98” as the threshold t3 of the explanatory variable x2 (variation in values of surrounding sections) in the third branch of the decision tree.

Finally, when the variation in the values of the surrounding sections is less than 78 (the thick solid line indicates a branch line), since the label data L, which is close to the abnormal state “0”, increases (approximately 0.1 or less), the learning part 52 automatically sets “78” as the threshold t4 of the explanatory variable x2 (variation in the values of surrounding sections) in the fourth branch of the decision tree.

The objective variables y1 to y5 (composite ratio) are determined based on the label data L and the appearance probability in the regions divided by the thresholds t1 to t4. For example, in the learning data set DS example shown in FIG. 9, the objective variable y1 is approximately 0.89, the objective variable y2 is approximately 0.02, the objective variable y3 is approximately 0.02, the objective variable y4 is approximately 0.05, and the objective variable y5 is approximately 0.02. It should be noted that the composite ratio (objective variables y1 to y5) may be such that the composite ratio of a specific filtered image is 1 and the composite ratio of the other filtered images is 0 depending on the learning data set DS.

As described above, the learning part 52 generates a decision tree model as shown in FIG. 10 by learning the learning data set DS. Furthermore, each time the learning data acquisition part 51 acquires a new learning data set DS, the learning part 52 converts the state of the model of the decision tree in accordance with the learning using the new learning data set DS. Specifically, the threshold value t is further adjusted to optimize the decision tree model. The learning part 52 outputs the generated learned decision tree model to the outside of the machine learning device 45.

The composite ratio setting part 44 shown in FIG. 3 sets the composite ratio C for each corresponding section of the plurality of filtered images using the learned decision tree model output from the machine learning device 45 (machine learning part). For example, according to the decision tree model shown in FIG. 10 generated from the learning data set DS of FIG. 9, if the variation in the values of the sections surrounding the predetermined section of the filtered images processed by a Sobel filter having a size exceeding 28 neighbors and below 60 neighbors (t1<x1<t2) exceeds 98 (x2>t3), since 0.89 (y1) is output as the composite ratio of the Sobel filter in the section, the composite ratio setting part 44 automatically sets the composite ratio of the Sobel filter in the section to 0.89.

Furthermore, if the variation in the values of the surrounding sections of a given section of the filtered image processed by a Sobel filter having a size of 28 neighbors or less (x1≤t1) exceeds 78 (x2>t4), since 0.05 (y4) is output as the composite ratio of the Sobel filter in the section, the composite ratio setting part 44 automatically sets the composite ratio of the Sobel filter in the section to 0.05. Likewise, the composite ratio setting part 44 automatically sets the composite ratio using the output learned decision tree model.

Although the decision tree model described above is a relatively simple model, since the imaging conditions and state of the workpiece W are limited to a certain extent in industrial applications, by learning under conditions tailored to the system, even simple feature extraction processing can achieve extremely high performance, leading to a significant reduction in processing time. Furthermore, it is possible to provide an improved feature extraction technology with which features of the workpiece W can stably be extracted in a short time.

Next, with reference to FIG. 11, the case in which a neuron (simple perceptron) model is used as the learning model LM1 for outputting the composite ratio will be described. FIG. 11 is a schematic view showing a neuron model. The neuron outputs one output y for a plurality of inputs x (inputs x1 to x3 in the example of FIG. 11). The individual inputs x1, x2, and x3 are each multiplied by a weight w (weights w1, w2, and w3 in the example of FIG. 11). A neuron model can be constructed using arithmetic circuits and memory circuits which imitate neurons. The relationship between the input x and the output y can be expressed by the following formula. In the following formula, θ is the bias and fₖ is the activation function.

$$\begin{matrix}[ Math 1 ] & \\ y = {f}_{k} ( \text{?} - θ ) & formula 1\end{matrix}$$

$$\text{?} \text{indicates text missing or illegible when filed}$$

In the example of the learning data set DS shown in FIG. 9, for example, the inputs x1, x2, and x3 are explanatory variables regarding at least one of the type and size of the filter F, and the output y is an objective variable regarding the composite ratio. Furthermore, the inputs x4, x5, x6, . . . and the corresponding weights w4, w5, w6, . . . may be added as necessary. For example, the inputs x4, x5, and x6 are explanatory variables regarding the variation in the values of the peripheral sections of the filtered image and the reaction of the filtered image.

Furthermore, by parallelizing a plurality of neurons to form one layer, multiplying the plurality of inputs x1, x2, x3, . . . by their respective weights w and inputting them to each neuron, a plurality of outputs y1, y2, y3, . . . regarding the composite ratio can be obtained.

The learning part 52 uses the learning data set DS to adjust the weight w using a learning algorithm such as a support vector machine to generate a neuron model. Furthermore, the learning part 52 converts the state of the neuron model according to the learning using the new learning data set DS. Specifically, the neuron model is optimized by further adjusting the weight w. The learning part 52 outputs the generated trained neuron model to the outside of the machine learning device 45.

The composite ratio setting part 44 shown in FIG. 3 automatically sets the composite ratio C for each corresponding section of the plurality of filtered images using the learned neuron model output from the machine learning device 45 (machine learning part).

Even though the neuron model described above is a relatively simple model, since the imaging conditions and the state of the workpiece W are limited to a certain extent in industrial applications, by learning under conditions tailored to the system, even if the feature extraction process is simple, very high performance can be obtained, leading to a significant reduction in processing time. Furthermore, it is possible to provide an improved feature extraction technology with which features of workpiece W can be extracted stably in a short time.

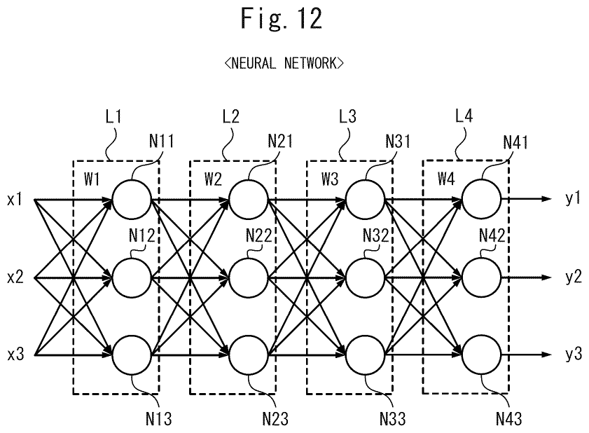

Next, with reference to FIG. 12, the case in which a neural network in which a plurality of neurons are combined into a plurality of layers is used as the learning model LM1 for outputting the composite ratio will be described. FIG. 12 is a schematic view showing the neural network model. The neural network includes an input layer L1, intermediate layers L2 and L3 (also referred to as hidden layers), and an output layer L4. Although the neural network in FIG. 12 includes two hidden layers L2 and L3, more hidden layers may be added.

The individual inputs x1, x2, x3, . . . of the input layer L1 are multiplied by the respective weights w (collectively expressed as weight W1), and are input to the respective neurons N11, N12, and N13. The individual outputs of the neurons N11, N12, and N13 are input to the intermediate layer L2 as feature amounts. In the intermediate layer L2, the input individual feature amounts are multiplied by the respective weights w (generally expressed as weight W2), and are input to the respective neurons N21, N22, and N23.

The individual outputs of the neurons N21, N22, and N23 are input to the intermediate layer L3 as feature amounts. In the intermediate layer L3, each input feature amount is multiplied by the respective weights w (generally expressed as weight W3), and are input to the respective neurons N31, N32, and N33. The individual outputs of the neurons N31, N32, and N33 are input to the output layer L4 as feature amounts.

In the output layer L4, the input individual feature amounts are multiplied by the respective weights w (generally expressed as weights W4), and are input to the respective neurons N41, N42, and N43. The individual outputs y1, y2, y3, . . . of the neurons N41, N42, and N43 are output as objective variables. A neural network can be constructed by combining arithmetic circuits and memory circuits which mimic neurons.

A neural network model can be constructed from multilayer perceptrons. For example, the input layer L1 multiplies the plurality of inputs x1, x2, x3, . . . , which are explanatory variables regarding the type of the filter F, by the respective weights w and outputs one or more feature amounts, the intermediate layer L2 multiplies the plurality of inputs which are explanatory variables regarding the input feature amounts and the size of filter F, by the respective weights w, and outputs one or more feature amounts, the intermediate layer L3 multiplies the one or more inputs, which are explanatory variables related to the input feature amounts and the variation in the values of the surrounding sections of a predetermined section of the filtered image, and the reaction of the predetermined section after threshold-processing the filtered image, by the respective weights w and outputs one or more feature amounts, and the output layer L4 outputs the plurality of outputs y1, y2, y3, . . . , which are objective variables regarding the input feature amounts and the composite ratio of a predetermined section of the filtered image.

Alternatively, the neural network model may be a model using a convolutional neural network (CNN). Specifically, the neural network may include an input layer for inputting a filtered image, one or more convolution layers for extracting features, one or more pooling layers for aggregating information, a fully connected layer, and a softmax layer for outputting the composite ratio for each predetermined section.

The learning part 52 performs deep learning using learning algorithms such as backpropagation (error backpropagation method) using the learning data set DS, and adjusts the weights W1 to W4 of the neural network to generate the neural network model. For example, in the learning part 52, it is desirable that the individual outputs y1, y2, y3, . . . of the neural network be compared with the label data L indicating the degree from the normal state to the abnormal state of a predetermined section, and error backpropagation be performed. Furthermore, in order to prevent overfitting, the learning part 52 may perform regularization (dropout) as necessary to simplify the neural network model.

The learning part 52 converts the state of the neural network model in accordance with the learning using the new learning data set DS. Specifically, the weights w are further adjusted to optimize the neural network model. The learning part 52 outputs the generated trained neural network model to the outside of the machine learning device 45.

The composite ratio setting part 44 shown in FIG. 3 automatically sets the composite ratio C for each corresponding section of the plurality of filtered images using the trained neural network model output from machine learning device 45 (machine learning part).

The neural network model described above can collectively handle more explanatory variables (dimensions) that have a correlation with the composite ratio of a predetermined section. Furthermore, when CNN is used, since feature amounts having a correlation with the composite ratio of the predetermined section are automatically extracted from the state S of the filtered image, there is no need to design explanatory variables.

In the case of any of the decision tree, neuron, and neural network models, the learning part 52 generates the learning model LM1 for outputting the composite ratio C for each predetermined section so that the features of the workpiece W extracted from the composite image composed of a plurality of filtered images based on the composite ratio C for each corresponding section approaches the model features of the workpiece W extracted from the model images of the workpiece W, for which at least one of the position and posture is known.

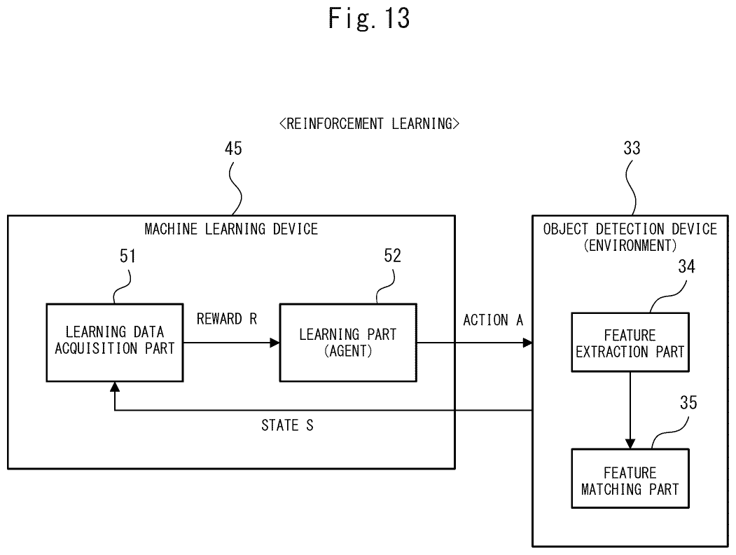

Next, with reference to FIG. 13, the case in which a reinforcement learning model is used as the learning model LM1 for outputting the composite ratio will be described. FIG. 13 is a schematic view showing the configuration of reinforcement learning. Reinforcement learning consists of a learning subject called an agent and an environment that is controlled by the agent. When the agent performs a certain action A, the state S in the environment changes, and a reward R is fed back to the agent as a result. The learning part 52 searches for the optimal action A through trial and error so as to maximize the total future reward R, rather than the immediate reward R.

In the example shown in FIG. 13, the agent is the learning part 52, and the environment is the object detection device 33 (object detection part). The action A by the agent is the setting of the composite ratio C for each corresponding section of the plurality of filtered images processed by a plurality of different filters F. Furthermore, the state S in the environment is the state of a feature extraction image generated by compositing the plurality of filtered images at a set composite ratio for each predetermined section. Furthermore, the reward R is a score obtained as a result of detecting at least one of the position and posture of the workpiece W by comparing the feature extraction image in a certain state S with the model feature extraction image. For example, if at least one of the position and posture of the workpiece W can be detected, the reward R is 100 points, and if neither the position nor posture of the workpiece W can be detected, reward R is 0 points. Alternatively, the reward R may be, for example, a score corresponding to the time taken to detect at least one of the position and posture of the workpiece W.

When the learning part 52 executes a certain action A (setting the composite ratio for each predetermined section), the state S (state of the feature extraction image) in the object detection device 33 changes, and the learning data acquisition part 51 acquires the changed state S and its result as the reward R, and feeds the reward R back to the learning part 52. The learning part 52 searches for the optimal action A (optimum composite ratio setting for each predetermined section) through trial and error so as to maximize the total future reward R, rather than the immediate reward R.

Reinforcement learning algorithms include Q-learning, Salsa, and Monte Carlo methods. Although Q learning will be described below as an example of reinforcement learning, the present invention is not limited to this. Q learning is a method of learning the value Q(S, A) for selecting the action A under the state S in a certain environment. Specifically, in a certain state S, the action A with the highest value Q(S, A) is selected as the optimal action A. However, at first, the correct value of the value Q(S, A) for the combination of the state S and the action A is not known at all. Thus, the agent selects various actions A under a certain state S, and is given a reward R for the action A at that time. As a result, the agent learns to choose a better action, i.e., the correct value Q(S,A).

The objective is to maximize the total reward R that can be obtained in the future as a result of the action. Thus, the ultimate aim is to make Q(S, A)=E[Σγ^{t}Rₜ] (expected discount value of reward; γ: discount rate, R: reward, t: time) (the expected value is taken when the state changes according to the optimal action; naturally, since the optimal action is not known, it is necessary to learn while exploring). An update formula for such value Q(S,A) can be expressed, for example, by the following formula.

$$\begin{matrix}[ Math 2 ] & \\ Q ( \text{?} ) ← Q ( \text{?} ) + \text{?} ( \text{?} + γ max Q ( \text{?} ) - Q ( \text{?} ) ) & formula 2\end{matrix}$$

$$\text{?} \text{indicates text missing or illegible when filed}$$

Here, St represents the state of the environment at time t, and Aₜ represents the action at time t. The state changes to Sₜ₊₁ due to the action Aₜ. Rₜ₊₁ represents the reward obtained by changing the state. Furthermore, terms with “max” are the Q value when action A with the highest Q value known at that time is selected under state Sₜ₊₁ multiplied by the discount rate γ. The discount rate γ is a parameter satisfying 0<γ≤1. α is a learning coefficient, which is in the range of 0<α≤1.

This formula represents a method of updating the evaluation value Q(Sₜ, Aₜ) of the action Aₜ in the state Sₜ based on the reward Rₜ₊₁ returned as a result of the attempted action Aₜ. If, compared to the evaluation value Q(Sₜ, Aₜ) of the action A in the state S, the evaluation value Q(Sₜ₊₁, maxAₜ₊₁) of the optimal action maxA in the next state due to reward Rₜ₊₁+action A is greater, Q(Sₜ, Aₜ) is increased, and conversely, if it is smaller, Q(Sₜ, Aₜ) is also decreased. Specifically, the value of a certain action in a certain state is brought closer to the immediate reward that results from that action and the value of the optimum action in the next state due to that action.

Examples of the method for expressing Q(S, A) on a computer include a method of storing the values as an action value table for all state and action pairs (S, A), and a method of preparing a function that approximates Q(S, A). In the latter method, the above-mentioned update formula can be realized by adjusting the parameters of the approximation function using a method such as stochastic gradient descent. As the approximation function, the neural network model described above can be used (so-called deep reinforcement learning).

Through the above reinforcement learning, the learning part 52 generates a reinforcement learning model for outputting the composite ratio C for each corresponding section of the plurality of filtered images. Furthermore, the learning part 52 converts the state of the reinforcement learning model according to the learning using the new learning data set DS. Specifically, the reinforcement learning model is optimized by further adjusting the optimal action A that maximizes the total future reward R. The learning part 52 outputs the generated trained reinforcement learning model to the outside of the machine learning device 45.

The composite ratio setting part 44 shown in FIG. 3 automatically sets the composite ratio C for each corresponding section of the plurality of filtered images using the trained reinforcement learning model output from the machine learning device 45 (machine learning part).

### <Learning Model LM2 of Set of Specified Number of Filters>

A classification model (learning model LM2) for a set of a specified number of filters F will be described below. Since classifying a set of a specified number of filters F is a problem in which a set of filters F exceeding the specified number is prepared in advance and the optimal set of filters F of a specified number is classified into groups, unsupervised learning is suitable. Alternatively, reinforcement learning may be performed to select the optimal set of filters F with the specified number of filters F from among the sets of filters F exceeding the specified number.

First, referring again to FIG. 13, the case in which a reinforcement learning model is used as the learning model LM2 for outputting the set of a specified number of filters F will be described. In the example shown in FIG. 13, the agent is the learning part 52, and the environment is the object detection device 33 (object detection part). The action A by the agent is selection of a set of a specified number of filters F (i.e., the selection of a specified number of filters F in which at least one of the type and size of filters F is changed). Further, the state S in the environment is a state for each corresponding section of the plurality of filtered images processed by the specified number of selected filters F. The reward R is a score corresponding to the label data L indicating the degree from normal state to abnormal state for each predetermined section of the plurality of filtered images in the certain state S.

When the learning part 52 executes a certain action A (the selection of a set of specified number of filters F), the state S (the state for each predetermined section of the plurality of filtered images) in the object detection device 33 changes, and the learning data acquisition part 51 acquires the changed state S and its result as the reward R, and feeds the reward R back to the learning part 52. The learning part 52 searches for the optimal action A (the selection of a set of optimal specified number of filters F) through trial and error so as to maximize the total future reward R, rather than the immediate reward R.

Through the above reinforcement learning, the learning part 52 generates a reinforcement learning model for outputting the set of a specified number of filters F. Furthermore, the learning part 52 converts the state of the reinforcement learning model according to the learning using the new learning data set DS. Specifically, the reinforcement learning model is optimized by further adjusting the optimal action A that maximizes the total future reward R. The learning part 52 outputs the generated trained reinforcement learning model to the outside of the machine learning device 45.

The filter set setting part 43 shown in FIG. 3 automatically sets a specified number of filters F using the learned reinforcement learning model output from the machine learning device 45 (machine learning part).

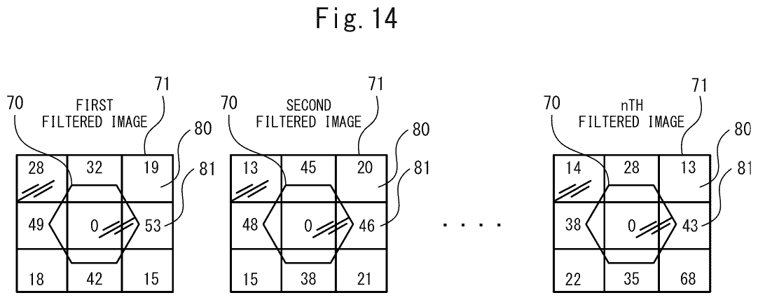

Next, with reference to FIGS. 14 to 16, the case in which an unsupervised learning model is used as the learning model LM2 for outputting the set of a specified number of filters F will be described. As a model for unsupervised learning, a clustering model (hierarchical clustering, non-hierarchical clustering, etc.) can be used. The learning data acquisition part 51 acquires the data regarding the plurality of different filters F and the data indicating the state S for each predetermined section of the plurality of filtered images as the learning data set DS.

The data regarding the plurality of filters F includes data regarding at least one of the types and sizes of the plurality of filters F exceeding the specified number. Furthermore, the data indicating the state S for each predetermined section of the plurality of filtered images is a reaction for each predetermined section after threshold-processing plurality of filtered images, but in another embodiment, variation in the values of surrounding sections for each predetermined section may also be used.

FIG. 14 is a schematic view showing reactions for each predetermined section of the plurality of filtered images. FIG. 14 shows reactions 81 for each predetermined section 80 after threshold-processing of the first to nth filtered images processed by the first to nth filters F (n is an integer) exceeding the specified number. Furthermore, the reaction 81 for each predetermined section 80 is the number of pixels equal to or greater than a threshold in a predetermined pixel group, such as, for example, an 8-neighbor pixel group, a 24-neighbor pixel group, or a 48-neighbor pixel group. The stronger the reaction 81 for each predetermined section 80 after threshold-processing of the first to nth filtered images, the higher the possibility that the features of the workpiece W can be suitably extracted. Thus, the learning part 52 generates learning model LM2 for classifying the set of a specified number of filters F so that the reaction for each section 80 is maximized in the first to nth filtered images.

For example, the case in which the designated number is 3 and the first to sixth filtered images are generated by processing with six first to sixth filters (n=6) exceeding the designated number will be considered. For example, the first filter is a small-sized Prewitt filter, the second filter is a medium-sized Previtt filter, the third filter is a large-sized Previtt filter, the fourth filter is a small-sized Laplacian filter, the fifth filter is a medium-sized Laplacian filter, and the sixth filter is a large-sized Laplacian filter.

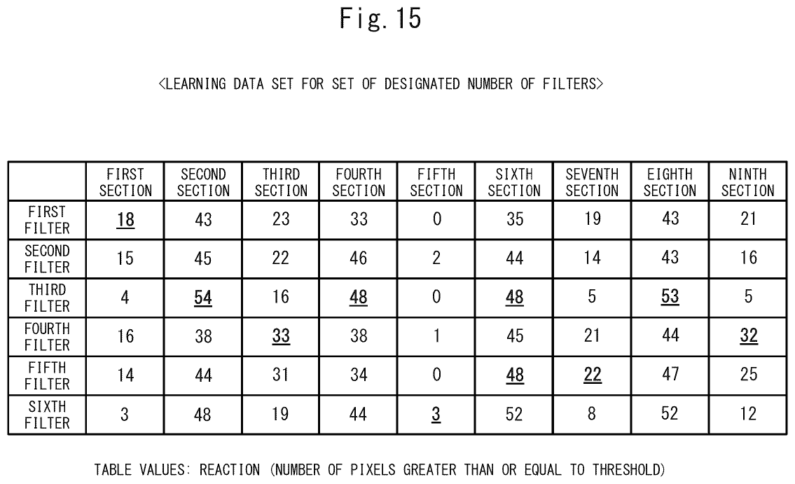

FIG. 15 is a table showing an example of a learning data set of a set of specified number of filters F. FIG. 15 shows the reactions (the number of pixels equal to or higher than the threshold) in the first to ninth sections after threshold-processing of the first to sixth filtered images processed by the first to sixth filters, respectively. The data exhibiting the maximum reaction in each section is highlighted in bold and underlined.

In unsupervised learning, the first to sixth filters are first classified into groups based on data indicating the reaction of each section. First, the learning part 52 calculates the distance D between data between filters as a classification criterion. For example, the Euclidean distance of the following formula can be used as the distance D. It should be noted that Fₐ and F_{b} are two arbitrary filters, Fₐᵢ and F_{bi} are data of each filter, i is a section number, and n is the number of sections.

$$\begin{matrix}[ Math 3 ] & \\ D ( \text{?} ) = \sqrt{\text{?} ( \text{?} - \text{?}} & formula 3\end{matrix}$$

$$\text{?} \text{indicates text missing or illegible when filed}$$

In the example of the learning data set DS shown in FIG. 15, the distance D between the data of the first filter and the second filter is approximately 18. Likewise, the learning part 52 calculates the distance D between data of arbitrary filters by round robin. Next, the learning part 52 classifies the filters having the closest distance D between data into cluster CL1, classifies the next closest filters into cluster CL2, and so on. When merging clusters, a simple connection method, a group average method, a Ward method, a centroid method, a median method, etc., can be used.

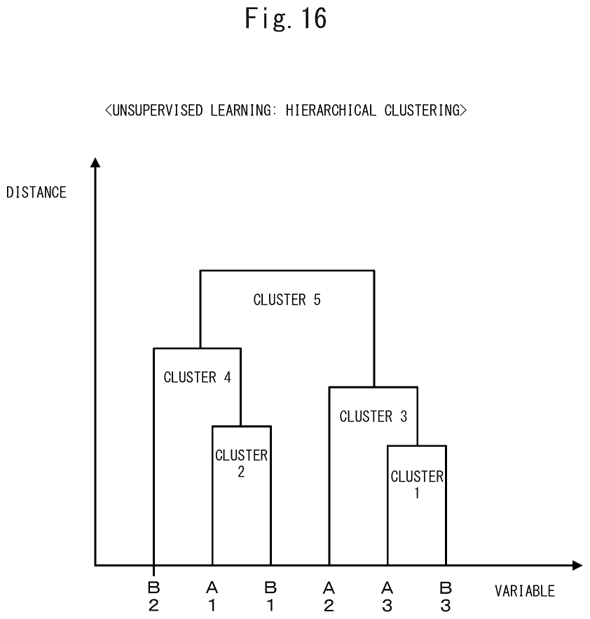

FIG. 16 is a tree diagram showing a model of unsupervised learning (hierarchical clustering). Variables A1 to A3 indicate the first to third filters, and variables B1 to B3 indicate the fourth to sixth filters. The learning part 52 classifies variables A3 and B3 having the closest distance D between the data into cluster CL1, classifies the next closest variables A1 and B1 into cluster CL2, and repeats this to generate a hierarchical clustering model. In the present example, since the specified number (i.e., the number of groups) is three, the learning part 52 may end the group classification after classifying into three clusters including cluster CL2 (first filter, fourth filter), cluster CL3 (second filter, third filter, sixth filter), and variable B2 (fifth filter).

Next, the learning part 52 generates a hierarchical clustering model so as to output a set of three filters having a large number of sections with the maximum reaction from each of the three clusters. In the example of FIG. 15, the fourth filter, third filter, and fifth filter, which have the largest number of sections with the maximum reaction, are output from each of the three clusters.

It should be noted that in another embodiment, the learning part 52 may generate a non-hierarchical clustering model instead of a hierarchical clustering model. As the non-hierarchical clustering, the k-means method, the k-means++ method, etc., can be used.

Through the above unsupervised learning, the learning part 52 generates an unsupervised learning model for outputting the set of a specified number of filters F. Furthermore, each time the learning data acquisition part 51 acquires a new learning data set DS, the learning part 52 converts the state of the unsupervised learning model according to the learning using the new learning data set DS. Specifically, the clusters are further adjusted to optimize the model for unsupervised learning. The learning part 52 outputs the generated trained unsupervised learning model to the outside of the machine learning device 45.

The filter set setting part 43 shown in FIG. 3 sets the set of a specified number of filters F using the learned unsupervised learning model output from the machine learning device 45 (machine learning part). For example, according to the hierarchical clustering model shown in FIG. 16 generated by learning data set DS of FIG. 15, the filter set setting part 43 automatically sets the fourth filter, third filter, and fifth filter as the optimal set of filters F of which specified number is 3.

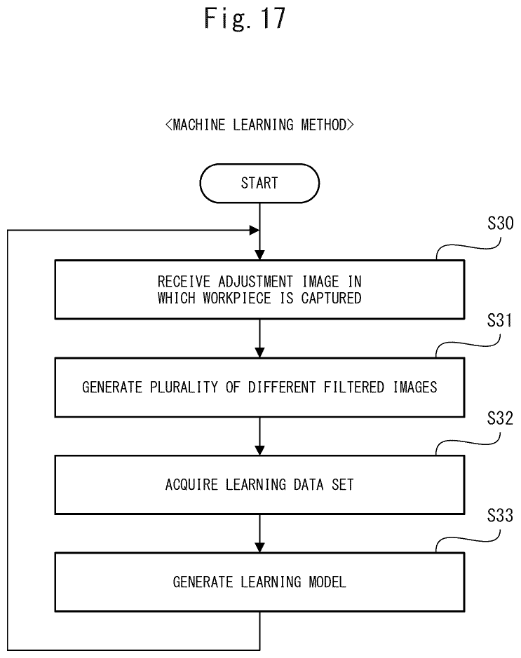

In the above embodiments, various types of machine learning have been explained, but below, the execution procedure of the machine learning method will be explained in summary. FIG. 17 is a flowchart showing the execution procedure of the machine learning method. First, in step S30, the image reception part 36 receives an adjustment image of the workpiece W. The adjustment image may be a model image obtained by capturing a workpiece W for which at least one of position and posture is known, or may be an image obtained by capturing a workpiece W for which at least one of position and posture is unknown.

In step S31, the feature extraction device 34 (feature extraction part) generates a plurality of filtered images by processing the received adjustment image with a plurality of different filters F. In step S32, the learning data acquisition part 51 acquires data regarding the plurality of different filters F and data indicating the state S for each predetermined section of the plurality of filtered images as the learning data set DS.

The data regarding the plurality of filters F includes at least one of the types and sizes of the plurality of filters F. Furthermore, the data indicating the state S for each predetermined section of plurality of filtered images may be data indicating variations in the values of sections surrounding the predetermined section of the filtered image, or may be data indicating the reaction for each predetermined section after threshold-processing of the plurality of filtered images. When performing supervised learning or reinforcement learning, as the data indicating the state S for each predetermined section, the label data L indicating the degree from the normal state to the abnormal state of the predetermined section of the filtered image, or the result (i.e., the reward R) of detecting at least one of the position and posture of the workpiece W by feature matching may further be included.

In step S33, the learning part 52 generates a learning model LM for outputting the composition parameter P for compositing the plurality of filtered images. The learning model LM includes at least one of the learning model LM1 for outputting the composite ratio C for each corresponding section of a plurality of filtered images, and the learning model LM2 for outputting the set of a specified number of filters F. Specifically, the composition parameter P output by the learning model LM1 is the composite ratio C for each predetermined section, and the composition parameter P output by the learning model LM2 is the set of a specified number of filters F.

By repeating steps S30 to S33, the learning part 52 converts the state of the learning model LM according to the learning based on the new learning data set DS. Specifically, the learning model LM is optimized. As post-processing of step S33, it may be determined whether the learning model LM has converged, and the learning part 52 may output the generated learned learning model LM to the outside of the machine learning device 45.

As described above, the machine learning device 45 uses machine learning to generate a learning model LM for outputting composition parameters for compositing the plurality filtered images and outputting them to the outside, whereby, for example, even if the workpiece W includes both fine features such as text and coarse features such as rounded corners, or when imaging conditions such as reference light illuminance and exposure time change, the feature extraction device 34 uses the output learned learning model LM to set the optimal composition parameters for compositing the plurality of filtered images, whereby it is possible to provide an improved feature extraction technology with which the features of the workpiece W which are optimal for feature matching can be extracted stably in a short time. Furthermore, the feature extraction device 34 generates and outputs the optimal feature extraction image, whereby the feature matching device 35 can provide an improvement in the feature matching technique, such as being able to stably detect at least one of the position and posture of the workpiece W in a short time using the output optimal feature extraction image.

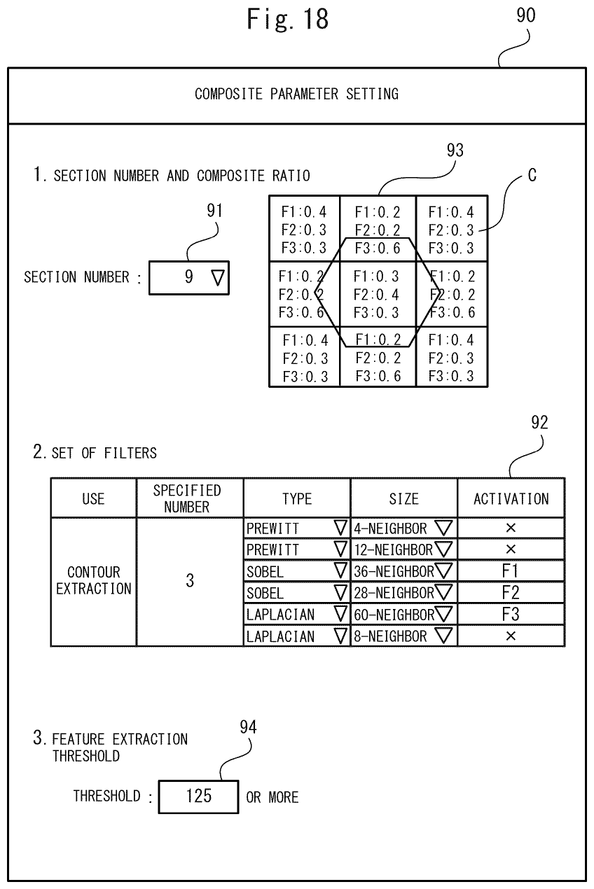

An example of a UI for setting the composition parameter P will be described below. FIG. 18 is a schematic view showing a UI 90 for setting the composition parameter P. As described above, the composition parameter P includes the set of a specified number of filters F, the composite ratio C for each predetermined section, and the like. Since the optimal set of filters F and the optimal composite ratio C for each predetermined section also change depending on the features of workpiece W and the imaging conditions, it is desirable that the composition parameter P be automatically adjusted using machine learning. However, the user may manually adjust the composition parameter P using the UI 90.

The UI 90 for setting composition parameters is displayed on, for example, the display of the teaching device 4 shown in FIG. 1. The UI 90 includes a section number specification part 91 for specifying the number of sections in which the plurality of filtered images are composited according to separate composite ratios, a filter set specification part 92 for specifying the set of a specified number of filters F (three first filters F1 to third filter F3 in the present example), a composite ratio specification part 93 for specifying the composite ratio C for each predetermined section, and a threshold specification part 94 for specifying a threshold for feature extraction.

First, the user uses the section number specification part 91 to specify the number of sections in which the plurality of filtered images are composited according to the different composite ratios C. For example, if one section is one pixel, the user need only specify the number of pixels of the filtered image in the section number specification part 91. In the present example, the number of sections is manually set to nine, so the filtered image is divided into nine rectangular areas of equal area.

Next, the user specifies the number of filters F, the types of the filters F, the sizes of the filters F, and the validation of the filters F in the filter set specification part 92. In the present example, the number of filters F is manually set to 3, the types and sizes of the filters F are manually set to a 36-neighbor Sobel filter (first filter F1), a 28-neighbor Sobel filter (second filter F2), and a 60-neighbor Laplacian filter (third filter F3), and these first filter F1 to third filter F3 are enabled.

Furthermore, the user specifies the composite ratio C of the plurality of filtered images for each section in the composite ratio specification part 93. In the present example, the composite ratio C of the first filter F1 to the third filter F3 is manually set for each section. Furthermore, the user specifies, in the threshold specification part 94, a threshold value for extracting the features of workpiece W from the composite image composed of the plurality of filtered images, or a threshold value for extracting a feature of workpiece W from a plurality of filtered images. In the present example, the threshold value is manually set to 125 or more.

When the above composition parameters are automatically set using machine learning, it is desirable that the UI 90 reflect the automatically set composition parameters and the like. According to such a UI 90, composition parameters can be manually set depending on the situation, and the state of automatically set composition parameters can be visually confirmed.

The program or software described above may be recorded and provided on a computer-readable non-transitory recording medium, such as a CD-ROM, or alternatively, may be distributed and provided from a server or the cloud on a WAN (wide area network) or LAN (local area network) via wired or wireless communication.

Although various embodiments have been described herein, it is recognized that the present invention is not limited to the embodiments described above, and various modifications can be made within the scope of the following claims.

### DESCRIPTION OF REFERENCE SIGNS

1 machining system
2 machine
3 controller
4 teaching device
5 visual sensor
21 mechanism part
22 end effector
23 actuator
31 memory part
32 control part
33 object detection part (object detection device)
34 feature extraction part (feature extraction device)
35 feature matching part
36 image reception part
41 multi-filter processing part
42 feature extraction image generation part
42a image composition part
42b threshold processing part
43 filter set setting part
44 composite ratio setting part
45 machine learning part (machine learning device)
51 learning data acquisition part
52 learning part
61 model image
62 model image with one or more changes
63 model feature
64 model feature extraction image
70 feature
71 filtered image
80 section
81 reaction
A action
C composite ratio
C1 reference coordinate system
C2 tool coordinate system
C3 workpiece coordinate system
D distance
DS data set
F, F1, F2, F3 filter
J1 to J6 axis line
L label data
LM, LM1, LM2 learning model
P composition parameter
R reward
S state
W workpiece

1. A machine learning device, comprising:
a learning data acquisition part which acquires, as a learning data set, data regarding a plurality of different filters applied to images in which a workpiece is captured, and data indicating a state of each predetermined section of a plurality of filtered images processed by the plurality of filters, and
a learning part which uses the learning data set to generate a learning model that outputs a composition parameter for compositing the plurality of filtered images for each corresponding section.

2. The machine learning device according to claim 1, wherein the learning model includes at least one of a first learning model that outputs a composite ratio for each corresponding section of the plurality of filtered images, and a second learning model that outputs a set of a specified number of filters.

3. The machine learning device according to claim 1, wherein the data regarding the plurality of filters includes data regarding at least one of types and sizes of the plurality of filters.

4. The machine learning device according to claim 1, wherein the data indicating a state of each predetermined section of the plurality of filtered images includes data indicating variations in values of peripheral sections of the predetermined section, or data indicating a reaction for each of the predetermined sections after threshold-processing of the plurality of filtered images.

5. The machine learning device according to claim 1, wherein the data indicating a state of each predetermined section of the plurality of filtered images includes label data indicating a degree from a normal state to an abnormal state for each predetermined section.

6. The machine learning device according to claim 1, wherein the learning part converts a state of the learning model so that a feature of the workpiece extracted from a composite image composed of the plurality of filtered images based on the composite ratio of each corresponding section approaches a model feature of the workpiece extracted from a model image in which the workpiece, for which at least one of position and posture is known, is captured.

7. The machine learning device according to claim 1, wherein the learning data acquisition part calculates the difference between the filtered images and a model feature extraction image extracted from a model image in which the workpiece, for which at least one of position and posture is known, is captured, and acquires label data indicating the degree from a normal state to an abnormal state for each of the predetermined sections of the plurality of filtered images.

8. The machine learning device according to claim 1, wherein the learning data acquisition part acquires label data indicating a degree from a normal state to an abnormal state for each predetermined section of the plurality of filtered images using one or more model feature extraction images extracted from the model image when one or more changes are made to the model image in which the workpiece, for which at least one of position and posture is known, is captured.

9. The machine learning device according to claim 8, wherein the one or more changes made to the model image include one or more changes that are used when comparing features of the workpiece extracted from an image of the workpiece and model features of the workpiece extracted from the model image.

10. The machine learning device according to claim 1, wherein the learning part generates the learning model using a result of detecting at least one of the position and posture of the workpiece by comparing the feature of the workpiece extracted from the image in which the workpiece is captured with a model feature extracted from a model image in which the workpiece, for which at least one of position and posture is known, is captured.

11. The machine learning device according to claim 1, wherein the data indicating a state of each predetermined section of the plurality of filtered images includes data indicating a reaction for each predetermined section after threshold-processing of the plurality of filtered images processed by the plurality of filters exceeding a specified number.

12. The machine learning device according to claim 1, wherein the learning part generates the learning model that outputs a set of a specified number of filters using a model image in which the workpiece, for which at least one of position and posture is known, is captured.

13. The machine learning device according to claim 1, wherein the learning part generates the learning model for outputting a set of a specified number of filters so that after threshold-processing of the plurality of filtered images processed by the plurality of filters exceeding the specified number, the reaction for each predetermined section becomes a maximum for each predetermined section.

14. A feature extraction device for extracting a feature of a workpiece from an image in which the workpiece is captured, the device comprising:
a multi-filter processing part for processing the image in which the workpiece is captured using a plurality of different filters to generate a plurality of filtered images, and
a feature extraction image generation part for generating and outputting a feature extraction image of the workpiece by compositing the plurality of filtered images based on a composite ratio for each corresponding section of the plurality of filtered images.

15. A controller for controlling operations of a machine based on at least one of a position and posture of a workpiece detected from an image in which the workpiece is captured, the controller comprising:
a feature extraction part for processing the image in which the workpiece is captured with a plurality of different filters to generate a plurality of filtered images, compositing the plurality of filtered images based on a composite ratio for each corresponding section of the plurality of filtered images and extracting a feature of the workpiece,
a feature matching part for comparing the extracted feature of the workpiece with a model feature extracted from a model image in which the workpiece, for which at least one of position and posture is known, is captured, and detecting at least one of the position and posture of the workpiece, for which at least one of position and posture is unknown, and
a control part for controlling the operations of the machine based on at least one of the detected position and posture of the workpiece.
